(19) United States
(12) Patent Application Publication
(10) Pub. No.: US 2003/0168266 A1
(43) Pub. Date: Sep. 11, 2003

(54) Brake control apparatus

(75) Inventors: Hiroki Sasaki, Yokohama-shi (JP); Hideo Nakamura, Yokohama-shi (JP); Junji Tsutsumi, Fujisawa-shi (JP); Kazuhiko Tazoe, Fujisawa-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Nissan Motor Co., Ltd., Yokohama-shi (JP)

(21) Appl. No.: 10/367,808

(22) Filed: Feb. 19, 2003

(30) Foreign Application Priority Data
Mar. 6, 2002 (JP) JP 2002-060982

(51) Int. Cl. B60K 6/02

(52) U.S. Cl. 180/65.3

(57) ABSTRACT

A brake control apparatus is configured to keep a regenerative braking torque imparted to a wheel at an appropriate level and to prevent it from becoming excessive in a case where a regenerative braking force produced by a motor generator is imparted to a wheel via a transmission. When the transmission installed between the wheel and the motor generators is a continuously variable transmission, a regenerative braking torque limit value is set such that it becomes smaller when a gear ratio of the continuously variable transmission becomes larger. For a given regenerative braking torque of the motor generators, the regenerative braking torque imparted to the wheels is larger when the gear ratio is larger. Consequently, the regenerative braking torque limit value is set such that the larger the gear ratio is, the smaller the regenerative braking torque limit value is.

### BACKGROUND OF THE INVENTION

1. Field of the Invention

The present invention generally relates to a brake control apparatus for a vehicle equipped with a motor generator for imparting a braking force to a wheel. The invention is particularly well suited for control of the regenerative braking force produced by the motor generator.

2. Background Information

Recently, some hybrid vehicles and electric vehicles are equipped with both a hydraulic braking system and a regenerative braking system. The regenerative braking system uses a motor-generator as a generator when a driver releases his foot from an accelerator pedal or when a brake pedal is depressed, and to decelerate a vehicle by transforming kinetic energy into electrical energy (regenerative braking). The electrical power which is then generated is stored in a battery or capacitor. Examples of this kind of brake control apparatus are described in Japanese Laid-Open Patent Publication No. 10-264793 and Japanese Laid-Open Patent Publication No. 2001-008306. These brake control apparatuses improve the energy recovery efficiency by responding to a requested braking force corresponding to the force with which the driver has depressed the brake pedal by mainly using the regenerative braking force that can be produced at that point in time and compensating for the amount by which the regenerative braking is insufficient using frictional braking, e.g., hydraulic braking.

In view of the above, it will be apparent to those skilled in the art from this disclosure that there exists a need for an improved brake control apparatus. This invention addresses this need in the art as well as other needs, which will become apparent to those skilled in the art from this disclosure.

### SUMMARY OF THE INVENTION

It has been discovered that in the conventional brake control apparatuses just described, braking is normally conducted using the maximum regenerative braking force that can be produced. When a transmission is disposed between the motor generator and the wheels, even if the regenerative braking force produced by the motor generator is constant, the regenerative braking force imparted to the wheels varies depending on the gear ratio of the transmission. Consequently, there are times when the braking force actually acting on the wheels is too large in comparison to the requested braking force.

The present invention was developed in order to solve these various problems with the conventional brake control apparatuses. One object is to provide a brake control apparatus that can impart an appropriate braking force to the wheels.

In order to achieve the aforementioned object, a brake control apparatus is provided that comprises a motor generator, a transmission and a controller. The motor generator is arranged and configured to produce a regenerative braking force that is to be imparted to a drive wheel. The transmission is operatively coupled to motor generator to transfer the regenerative braking force from the motor generator to the drive wheel through the transmission. The controller is operatively coupled to the motor generator and configured to control a maximum value of the regenerative braking force based on a gear ratio of the transmission.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic view of a hybrid vehicle with a cooperative braking system that exemplifies a regenerative cooperative braking control apparatus in accordance with one embodiment of the present invention;

FIG. 2 is a block diagram of the braking torque command value calculation executed by the regenerative cooperative braking control unit;

FIG. 3 is a flowchart showing the processing used for calculating the brake fluid pressure command value and the regenerative torque command value based on the braking torque command value calculation shown in FIG. 2;

FIG. 4 shows a pair of control maps used during the processing shown in FIG. 3;

FIG. 5 shows a control map used during the processing shown in FIG. 3;

FIG. 6 is a control map used during the processing shown in FIG. 3;

FIG. 7 is a time chart showing the change in vehicle deceleration resulting from the processing shown in FIG. 3;

FIG. 8 shows three time charts that illustrate the change in braking torque and vehicle deceleration resulting from the processing shown in FIG. 3; and

FIG. 9 shows three time charts that illustrate the change in vehicle deceleration resulting from conventional braking force control.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

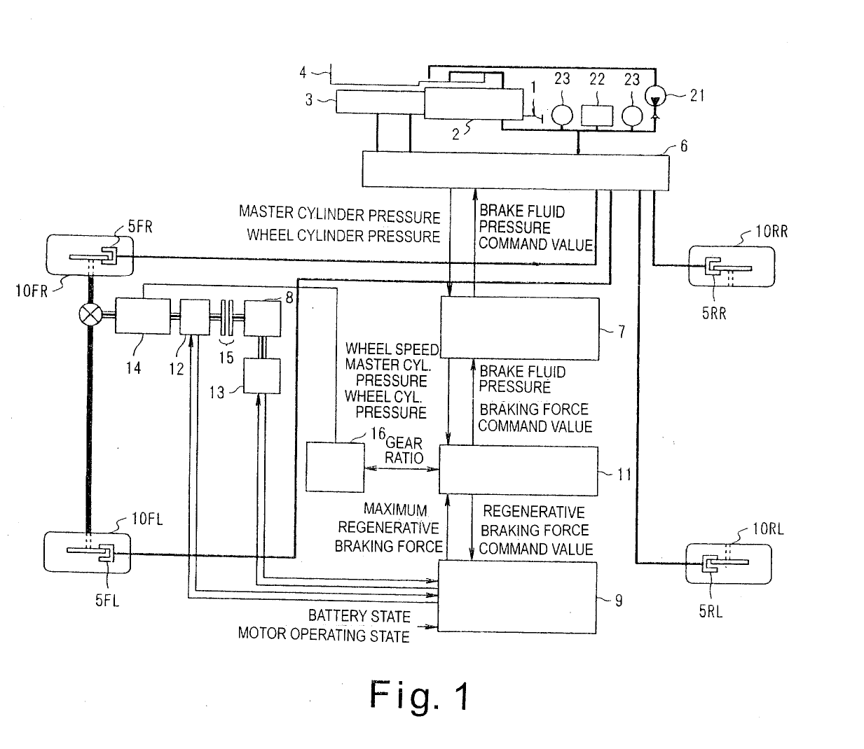

Referring initially to FIG. 1, a hybrid vehicle with a vehicle braking system is schematically illustrated that utilizes a brake control apparatus in accordance with a first embodiment of the present invention. The vehicle braking system is a hydraulic-regenerative cooperative brake control system that efficiently recovers regenerative energy by executing control to reduce the brake fluid pressure when it is controlling the regenerative braking torque by way of an AC synchronous motor. The hydraulic braking portion of the hybrid vehicle basically includes a brake pedal 1, a booster 2, a master cylinder 3, a brake fluid reservoir 4, a plurality of wheel cylinders 5FL, 5FR, 5RL and 5RR, a brake fluid pressure circuit 6 and a brake fluid pressure control unit 7. The regenerative braking portion of the vehicle braking system is operatively controlled in response to various vehicle operating conditions or states of various components of the hybrid vehicle. The hybrid vehicle further includes an internal combustion engine 8, a motor control unit 9, a set of wheel 10FL, 10FR, 10RL and 10RR a regenerative cooperative braking control unit 11, a pair of motor generators 12 and 13, a continuously variable transmission (CVT) 14, a clutch 15 and a continuously variable transmission (CVT) control unit 16.

As explained below in more detail, the brake control apparatus of the present invention is constructed such that a regenerative braking force or torque produced by the motor generator 12 can be imparted to at least one of the drive wheels 10FL and 10FR via the continuously variable transmission 14 and the maximum value of regenerative braking force or torque inputted to the continuously variable transmission 14 from the motor generator 12 is limited in accordance with the gear ratio of the continuously variable transmission 14. Therefore, if the maximum value of the regenerative braking force or torque is set such that the larger the gear ratio is the smaller the maximum value of the regenerative braking force or torque is, then the regenerative braking force or torque imparted to the drive wheels 10FL and 10FR can be prevented from becoming too large and an appropriate regenerative braking force or torque can be imparted to the drive wheels 10FL and 10FR.

The brake pedal 1 is operatively linked to the master cylinder 3 in a conventional manner via the booster 2. Thus, the brake pedal 1 is operated by the driver depressing and/or releasing the brake pedal 1 to operate the master cylinder 3. The booster 2 is utilizes the high-pressure brake fluid pressurized by a pump 21 and stored in an accumulator 22 to multiply the force with which the brake pedal is depressed and deliver the multiplied force to the master cylinder 3. The pump 21 is sequence-controlled by a pressure switch 23. Item 4 in the figure is a brake fluid reservoir 4.

The master cylinder 3 is connected to the wheel cylinders 5FL, 5FR, 5RL and 5RR of wheels 10FL, 10FR, 10RL and 10RR, respectively. The brake fluid pressure circuit 6 is located along the brake fluid path between the wheel cylinders 5FL, 5FR, 5RL and 5RR of wheels 10FL, 10FR, 10RL and 10RR. The brake fluid pressure circuit 6 basically includes a stroke simulator, a stroke simulator selector valve, a pressure increasing valve and a pressure reducing valve.

The stroke simulator selector valve serves to switch the brake fluid pressure of the master cylinder 3 between the stroke simulator and the wheel cylinders 5FL, 5FR, 5RL and 5RR. In short, the master cylinder 3 is connected to the wheel cylinders 5FL, 5FR, 5RL and 5RR when the stroke simulator selector valve is not energized, and the master cylinder 3 is connected to the stroke simulator such that the wheel cylinders 5FL, 5FR, 5RL and 5RR are cut off from the brake fluid pressure of the master cylinder 3 when the stroke simulator selector valve is energized. Depending on the operation of the stroke simulator selector valve, the pressure increasing valve serves to increase the pressure by supplying the output pressure of the pump 21 or the stored pressure of the accumulator 22 to the wheel cylinders 5FL, 5FR, 5RL and 5RR. The pressure reducing valve, on the other hand, serves to reduce the pressure by returning the brake fluid pressure of the wheel cylinders 5FL, 5FR, 5RL and 5RR to the reservoir 4. In particular, the pressure increasing valve interrupts the connection between the wheel cylinders 5FL, 5FR, 5RL and 5RR and either the pump 21 or the accumulator 22 when it is not energized and connects the wheel cylinders 5FL, 5FR, 5RL and 5RR to either the pump 21 or the accumulator 22 when it is energized. Meanwhile, the pressure reducing valve interrupts the connection between the wheel cylinders 5FL, 5FR, 5RL and 5RR and the reservoir 4 when it is not energized and connects the wheel cylinders 5 to the reservoir 4 when it is energized. Therefore, in a state where the wheel cylinders 5 are disconnected from the master cylinder 3 by the stroke simulator selector valve, the brake fluid pressure in the wheel cylinders 5FL, 5FR, 5RL and 5RR can be increased independently from the output pressure of the master cylinder 3 by energizing the pressure increasing valve. Also, in a state where the wheel cylinders 5 are disconnected from the master cylinder 3 by the stroke simulator selector valve, the brake fluid pressure in the wheel cylinders 5 can be reduced independently from the output pressure by energizing the pressure reducing valve.

The brake fluid pressure circuit 6 is also provided with a master cylinder sensor that detects the output pressure of the master cylinder 3 and the wheel cylinder sensors that detect the brake fluid pressure at the wheel cylinders 5 when they are disconnected from the master cylinder 3. The signals from these sensors are fed to the brake fluid pressure control unit 7.

The drive wheels of the vehicle are the front wheels 10FL and 10FR, which are driven by both the internal combustion engine 8 and the motor generators 12 and 13, i.e., two AC electric motors. The motor generator 12 is connected to the front wheels 10FL and 10FR via the continuously variable transmission (CVT) 14 with the clutch 15 installed between the motor generator 12 and the engine 8. In short, the motor generator 12 and the engine 8 are arranged in a parallel hybrid manner. Meanwhile, the motor generator 13 is connected directly to the engine 8 in a so-called serial hybrid arrangement. These motor generators 12 and 13 can drive the front wheels 10FL and 10FR by functioning as an electric motor running off electric power supplied by a battery. These motor generators 12 and 13 can also store electricity in the battery by functioning as a generator running off road-surface drive torque. When restoring electric power to the battery, road-surface drive torque is consumed in order to rotate the motor generators 12 and 13. In effect, a braking force is imparted to the drive wheels 10FL and 10FR. Such braking is regenerative braking. In this embodiment, the regenerative cooperative braking control unit 11 is constructed such that a portion of the total braking force or torque that is in excess of a braking force or torque corresponding to the ideal braking force or torque distribution with respect to the rear wheels 10RL and 10RR (which are not drive wheels) can be imparted to the front wheels 10FL and 10FR (which are drive wheels) as a regenerative braking force or torque.

The motor generators 12 and 13 are controlled by commands from the motor control unit 9. More specifically, the drive state of the motor generators 12 and 13 and the regenerative braking state are controlled. For example, when the vehicle starts to move from a stopped position, the motor generators 12 and 13 operate as an electric motor and drive the drive wheels, i.e., the front wheels 10FL and 10FR. Conversely, when the vehicle is traveling on inertia or decelerating, the motor generators 12 and 13 operate as a generator and impart a regenerative braking force or torque. Therefore, the operating states or conditions of the motor generators 12 and 13 and the battery state are fed to the motor control unit 9.

The brake fluid pressure control unit 7 and the motor control unit 9 are connected through a communication circuit to a regenerative cooperative brake control unit 11. In one mode, the brake fluid pressure control unit 7 and the motor control unit 9 can control the brake fluid pressure of the wheel cylinders 5FL, 5FR, 5RL and 5RR and the operating state of the motor generators 12 and 13, respectively, in a standalone manner. In another mode, brake fluid pressure control unit 7 and the motor control unit 9 can recover the kinetic energy of the vehicle and improve the fuel consumption in an efficient manner by executing these control operations in response to commands issued from the regenerative cooperative brake control unit 11.

More specifically, the motor control unit 9 controls the regenerative braking torque or force based on regenerative braking torque command values received from the regenerative cooperative brake control unit 11. The motor control unit 9 also calculates the maximum allowable regenerative braking torque or force based on factors, operating states or conditions such as the charged state and temperature of the battery and then sends the results to the regenerative cooperative brake control unit 11. While the description of present invention uses braking torque to describe a preferred embodiment, it will be apparent to those skilled in the art from this disclosure that the present invention can also be expressed in terms of braking force.

Meanwhile, the brake fluid pressure control unit 7 controls the brake fluid pressure of the wheel cylinders 5FL, 5FR, 5RL and 5RR in response to the brake fluid pressure command values received from the regenerative cooperative brake control unit 11. The brake fluid pressure control unit 7 also sends the wheel speed or the master cylinder pressure and wheel cylinder pressure detected by the master cylinder pressure sensor and wheel cylinder pressure sensor to the regenerative cooperative brake control unit 11. The regenerative cooperative brake control unit 11 also communicates with the continuously variable transmission control unit 16, which controls the continuously variable transmission 14. The continuously variable transmission control unit 16 sends the current gear ratio of the continuously variable transmission 14 to the regenerative cooperative brake control unit 11.

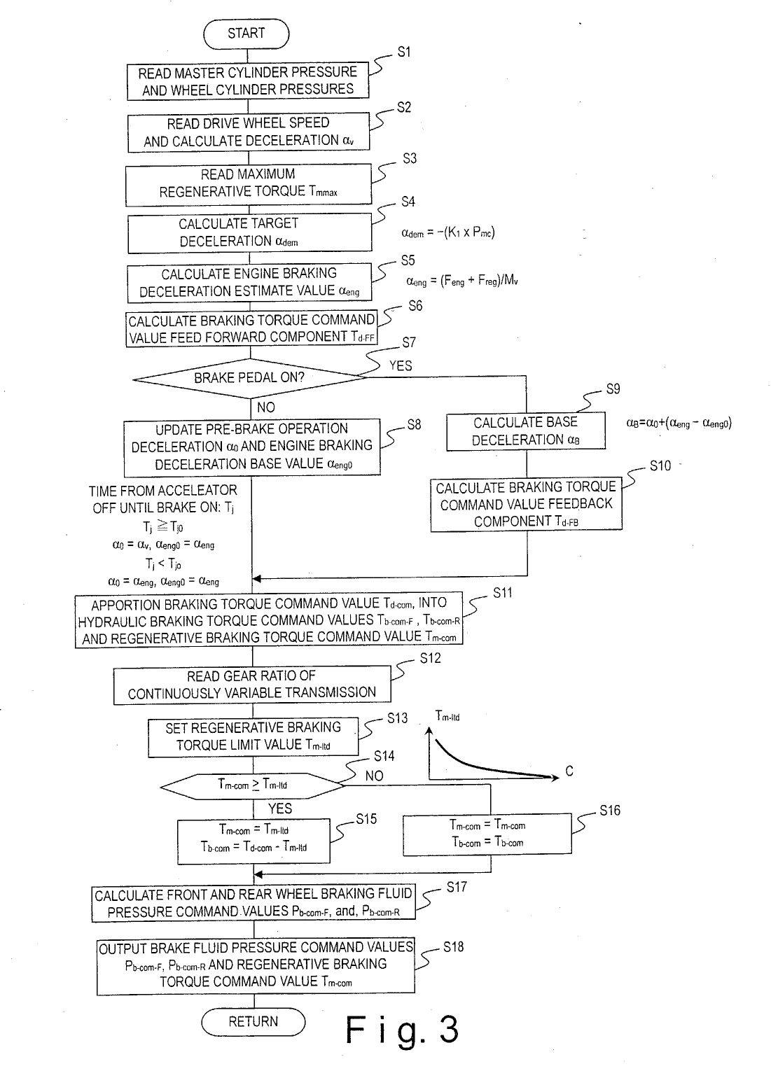

Each of the control units (i.e., the brake fluid pressure control unit 7, the motor control unit 9, the regenerative cooperative brake control unit 11 and the continuously variable transmission unit 16) preferably includes a microcomputer or other processing device with control programs that controls the processes and calculates the various values as discussed below. Of course, it will be apparent to those skilled in the art from this disclosure that the control units 7, 9, 11 and 16 can be combined together as needed and/or desired. Each of the control units 7, 9, 11 and 16 can also include other conventional components such as an input interface circuit, an output interface circuit, and storage devices such as a ROM (Read Only Memory) device and a RAM (Random Access Memory) device. The microcomputers of the control units 7, 9, 11 and 16 are programmed to control the hydraulic and regenerative braking systems in accordance with the flow chart of FIG. 3. The memory circuits of the control units 7, 9, 11 and 16 store processing results, various parameters and control maps for controlling the hydraulic and regenerative braking systems in accordance with the flow chart of FIG. 3. The internal RAM of control units 7, 9, 11 and 16 store statuses of operational flags and various control data. The internal ROM of controller 31 stores the control maps for various operations of the hydraulic and regenerative braking systems. It will be apparent to those skilled in the art from this disclosure that the precise structure and algorithms for the control units 7, 9, 11 and 16 can be any combination of hardware and software that will carry out the functions of the present invention. In other words, “means plus function” clauses as utilized in the specification and claims should include any structure or hardware and/or algorithm or software that can be utilized to carry out the function of the “means plus function” clause.

The brake fluid pressure control unit 7 and the motor control unit 9 create drive signals and control signals based on the command values and feed the signals to the aforementioned actuators. Meanwhile, the regenerative cooperative brake control unit 11 calculates the brake fluid pressure command value and regenerative torque command value that enable a degree of deceleration that matches the intention of the driver to be obtained and the vehicle kinetic energy to be recovered efficiently and sends these command values to the brake fluid pressure control unit 7 and the motor control unit 9, respectively.

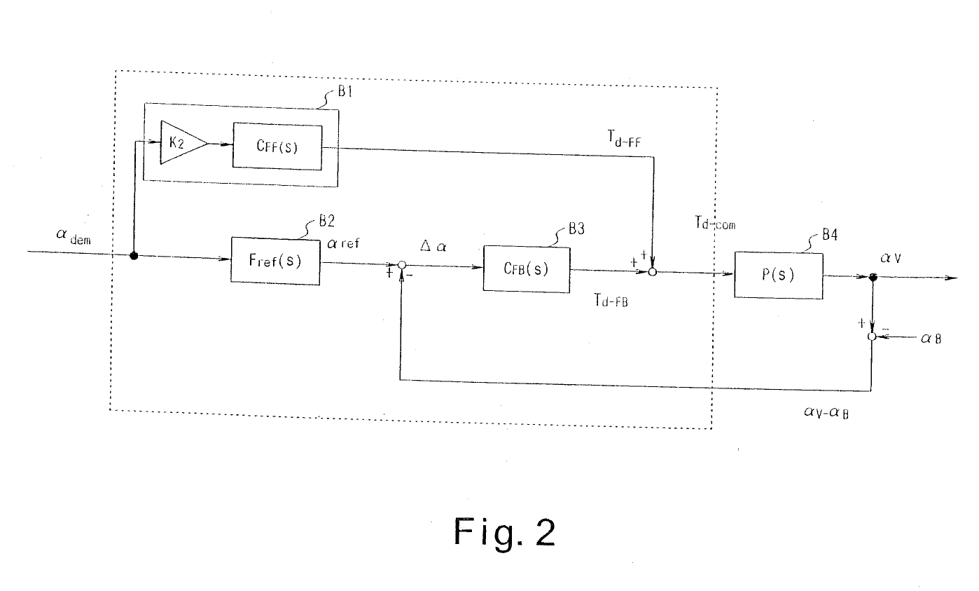

Next, one preferred method of calculating the braking torque command value T_{d-com}, which is necessary for the regenerative cooperative brake unit 19 to calculate a hydraulic braking torque command value T_{b-com}, and a regenerative braking torque command value T_{m-com}, will be explained based on the block diagram shown in FIG. 2. A target deceleration α_{dem} is first obtained to calculate the braking torque command value T_{d-com}. For example, assume the target deceleration α_{dem} is a value proportional to the amount by which the brake pedal 1 is depressed (i.e., the braking operation amount which is the amount by which the brake is operated) by the driver, i.e., proportional to the master cylinder pressure P_{mc}. A feed forward component T_{d-FF} of the braking torque command value T_{d-com} is obtained based on the target deceleration α_{dem} alone, while a feedback component T_{d-FB} of the braking torque command value T_{d-com} is obtained by feeding back an actual vehicle deceleration UV that is being experienced by the vehicle. The feed forward component T_{d-FF} and the feedback component T_{d-FB} are added together to obtain the braking torque command value T_{d-com}.

Referring to FIG. 2, a response characteristic P(s) in block B4 corresponds to the vehicle, which the vehicle deceleration αᵥ is the deceleration achieved or actually experienced by the vehicle. Defining a base deceleration α_{B} as the deceleration immediately before application of the brake begins, e.g., deceleration resulting from engine braking or an upward slope or acceleration resulting from a downward slope, the deceleration to be achieved by the brake control system is the value obtained when the base deceleration α_{B} is subtracted from the vehicle deceleration UV (i.e., αᵥ−α_{B}).

First, at block B1 of FIG. 2, the feed forward component T_{d-FF} of the braking torque command value T_{d-com} is calculated using Equation 1 as shown below. The feed forward component T_{d-FF} is used to make the vehicle model response characteristic Pₘ(s) (first order time delay characteristic having time constant Tₚ) match the ideal reference model response characteristic F_{ref}(s) of the vehicle (first order time delay characteristic having time constant Tᵣ). The feed forward component T_{d-FF} of the braking torque command value T_{d-com} is calculated by applying a feed forward phase compensator C_{FF}(s) processing to the target deceleration α_{dem}. In Equation 1 below, a constant K₂ is associated with various vehicle factors. Thus, the constant K₂ is used for converting the target deceleration α_{dem} into braking torque.

Equation 1:

T_{d-FF}=C_{FF}(s)K₂α_{dem},

where C_{FF}(s)=F_{ref}(s)/Pₘ(s)=(Tₚ·s+1)/(Tᵣ·s+1) (1)

Meanwhile, a reference deceleration α_{ref} is calculated, which is used to calculate the feedback component T_{d-FB} of the braking torque command value T_{d-com}, the reference deceleration α_{ref} is calculated by applying the reference model response characteristic F_{ref}(s) processing shown in Equation 2 below to the target acceleration α_{dem} in block B2.

Equation 2:

F_{ref}(s)=1/(Tᵣ·S+1) (2)

The feedback difference value Δα is then calculated by subtracting the difference between the vehicle deceleration αᵥ and the base deceleration α_{B}, i.e., (αᵥ−α_{B}), from the calculated reference deceleration value α_{ref} using an adder-subtracter. Then, in block B3, the feedback compensator C_{FB}(s) processing shown in Equation 3 below is applied to the feedback difference value Δα to calculate the feedback component T_{d-FB} of the braking torque command value T_{d-com}. The feedback compensator C_{FB}(s) is preferably a basic proportional integral (PI) controller. Control constants K_{P} and K_{I} in the Equation 3 are established in view of a gain margin and a phase margin.

Equation 3:

C_{FB(s)}=(K_{P}·s+K₁)/s (3)

Thus, the braking torque command value T_{d-com} can be calculated by adding the feed forward component T_{d-FF} of the braking torque command value to the feedback component T_{d-FB} of the braking torque command value using an adder.

Now, the flowchart shown in FIG. 3 will be used to explain the processing that the regenerative cooperative braking control unit 11 executes in order to calculate the brake fluid pressure command value and the regenerative torque command value.

This processing is executed by timer interruption every time a prescribed time period ΔT (e.g., 10 milliseconds) elapses. Although the flowchart does not include steps specifically for communications, information obtained by way of the computations is stored as necessary and stored information is retrieved as necessary.

In step S1, the regenerative cooperative braking control unit 11 receives the master cylinder pressure P_{mc} detected by the master cylinder pressure sensor and the wheel cylinder pressure P_{wc} detected by the wheel cylinder pressure sensors from the brake fluid pressure control unit 7.

In step S2, the regenerative cooperative braking control unit 11 reads the drive wheel speed detected by the drive wheel speed sensor as the traveling speed of the vehicle and uses the transfer function F_{bpf}(s) shown in Equation 4 to apply a band pass filter processing to the drive wheel speed, and thereby, determine the drive wheel deceleration. The regenerative cooperative braking control unit 11 then designates the result as the vehicle deceleration αᵥ actually experienced by the vehicle. In the equation, [symbol] is a natural angular frequency and ζ is a dampening constant.

Equation 4:

F_{bpf}(s)=s/(s²/ [symbol] ²+2ζs/ [symbol] +1) (4)

In step S3, the regenerative cooperative braking control unit 11 receives the maximum available regenerative torque Tₘₘₐₓ from the motor control unit 9.

In step S4, the regenerative cooperative braking control unit 11 multiplies the master cylinder pressure P_{mc} received in step S1 by a constant K₁ and calculates the negative value thereof as the target deceleration α_{dem}.

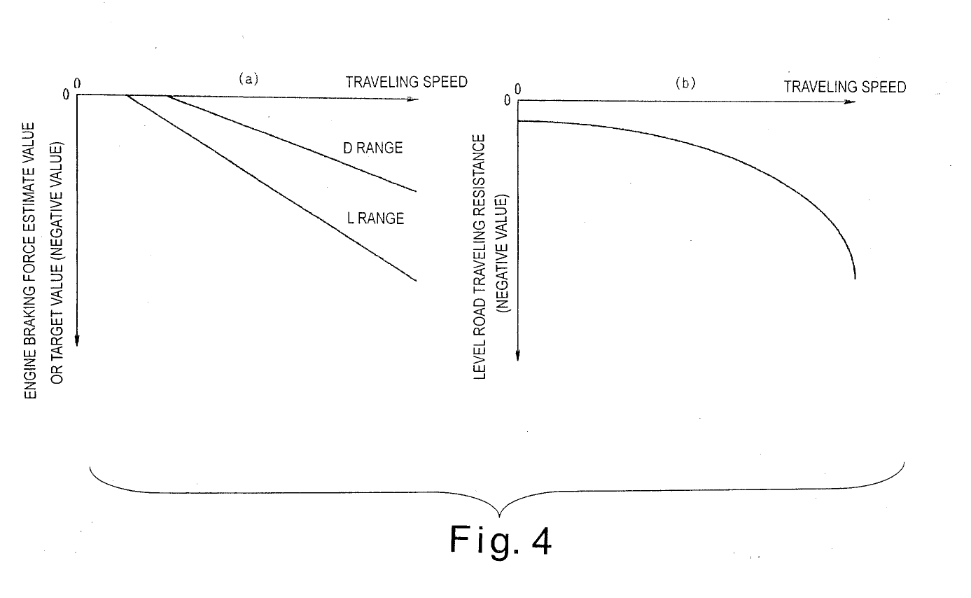

In step S5, the regenerative cooperative braking control unit 11 then calculates an estimate of the deceleration resulting from the engine braking force, i.e., an engine braking deceleration estimated value α_{eng}. More specifically, the drive wheel speed received in step S2 is designated as the traveling speed of the vehicle and the engine braking estimate value or target value F_{eng} is found based on the traveling speed and shift position using the control map (a) of FIG. 4. Simultaneously, the traveling resistance F_{reg} for a level road is found based on the vehicle traveling speed using the control map (b) of FIG. 4. Then, the sum of the two forces is divided by an averaged vehicle weight Mᵥ to calculate the engine braking deceleration estimated value α_{eng}.

In step S6, the regenerative cooperative braking control unit 11 calculates the feed forward component T_{d-FF} of the braking torque command value T_{d-com} by applying the feed forward phase compensator C_{FF}(s) that processes Equation 1 to the target deceleration α_{dem} calculated in step S4.

In step S7, the regenerative cooperative braking control unit 11 determines if the vehicle is in the brake pedal ON (brake operation) state, i.e., if the brake pedal 1 is being depressed, by using such factors as whether or not the master cylinder pressure P_{mc} received in step S1 is greater than or equal to a relatively small prescribed value. If the brake pedal is in the ON state, the regenerative cooperative braking control unit 11 proceeds to step S9. If not, the regenerative cooperative braking control unit 11 proceeds to step S8.

In step S8, the regenerative cooperative braking control unit 11 updates the pre-brake operation deceleration α₀ and the engine braking deceleration base value α_{eng0} and proceeds to step S11. More specifically, the brake start time Tⱼ, which is the time from release of the accelerator pedal (accelerator OFF) until operation of the brake (brake ON), is found. If the brake start time Tⱼ is greater than or equal to a prescribed value Tⱼ₀, which corresponds to, for example, the time required for the engine braking force to converge, then the vehicle deceleration αᵥ calculated in step S2 is assigned as the pre-brake operation deceleration α₀ and the engine braking deceleration estimated value α_{eng} calculated in step S5 is assigned as the engine braking deceleration base value α_{eng0}.

Meanwhile, if the brake start time Tⱼ is less than the prescribed value Tⱼ₀, the engine braking deceleration estimated value α_{eng} calculated in step S5 is assigned as the pre-brake operation deceleration α₀ and the same engine braking deceleration estimated value α_{eng} is assigned as the engine braking deceleration base value α_{eng0}. In short, the actual vehicle deceleration αᵥ is used as the pre-brake operation deceleration α₀ when the brake start time Tⱼ is greater than or equal to prescribed value Tⱼ₀ (which corresponds to the time required for engine braking to converge). On the other hand, the engine braking deceleration estimated value α_{eng} (which is expected to occur) is used as the pre-brake operation deceleration α₀ when the brake start time Tⱼ is below the prescribed value Tⱼ₀.

Meanwhile, in step S9, if the brake pedal 1 is depressed (brake ON), then the regenerative cooperative braking control unit 11 calculates the base deceleration α_{B}. The regenerative cooperative braking control unit 11 calculates the base deceleration α_{B} by adding the value obtained by subtracting the engine braking deceleration base value α_{eng0} from the engine braking deceleration estimated value α_{eng} calculated in step S5 to the pre-brake operation deceleration α₀. Control then proceeds to step S10.

In step S10, the regenerative cooperative braking control unit 11 calculates the feedback component T_{d-FB} of the braking torque command value. The feedback component T_{d-FB} of the braking torque command value is calculated by first calculating the reference deceleration α_{ref}. The regenerative cooperative braking control unit 11 calculates the reference deceleration α_{ref} by applying the reference model response characteristic F_{ref}(s) that processes Equation 2 to the target deceleration α_{dem}. The regenerative cooperative braking control unit 11 then uses the base deceleration α_{B} calculated in step S9 to calculate the deceleration feedback difference value Δα by subtracting the difference between the vehicle deceleration αᵥ and the base deceleration α_{B} (i.e., αᵥ−α_{B}) from the reference deceleration α_{ref}. Then, the regenerative cooperative braking control unit 11 calculates the feedback component T_{d-FB} of the braking torque command value by applying the feedback compensator C_{FB}(s) that processes Equation 3 to the deceleration feedback difference value Δα. The regenerative cooperative braking control unit 11 then proceeds to step S11.

In step S11, the regenerative cooperative braking control unit 11 calculates the braking torque command value T_{d-com} and apportions the braking torque command value T_{d-com} into the hydraulic braking torque command value T_{b-com} and the regenerative braking torque command value T_{m-com}. First, the regenerative cooperative braking control unit 11 calculates the braking torque command value T_{d-com} by adding together the feed forward component T_{d-FF} of the braking torque command value T_{d-com} calculated in step S6 and the feedback component T_{d-FB} of the braking torque command value T_{d-com} calculated in step S10. The regenerative cooperative braking control unit 11 then apportions the braking torque command value T_{d-com} into the hydraulic braking torque command value T_{b-com} and the regenerative braking torque command value T_{m-com}. In order to improve the fuel economy as much as possible, the braking torque command value T_{d-com} is apportioned by the regenerative cooperative braking control unit 11 such that as much of the maximum regenerative torque Tₘₘₐₓ received in step S3 is used as possible.

In this embodiment, the motor generators 12 and 13 only drives the front wheels 10FR and 10FL and executes regenerative braking using road-surface drive torque from the front wheels 10FR and 10FL. Therefore, the apportionment is handled differently depending on the situation.

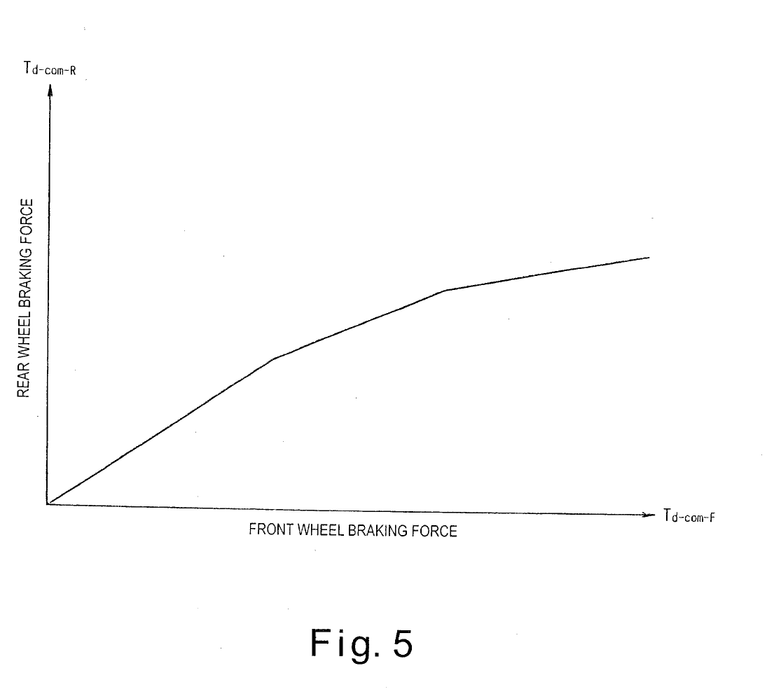

First, the braking torque command value T_{d-com} is apportioned into a front wheel braking torque command value T_{d-com-F} and a rear wheel braking torque command value T_{d-com-R} according to the front-rear wheel braking force distribution control map (e.g., an ideal braking force distribution map) shown in FIG. 5. Then, the apportionment is executed in accordance with the following Formula 30 in which terms are expressed in absolute values.

Formula 30:

(1) Tₘₘₐₓ>T_{d-com-F}+T_{d-com-R}, then

T_{m-com}=T_{d-com-F}+T_{d-com-R}=T_{d-com}

T_{b-com-F}=0

T_{b-com-R}=0

(2) T_{d-com-F}+T_{d-com-R}≧Tₘₘₐₓ>T_{d-com-F}, then

T_{m-com=T}ₘₘₐₓ

T_{b-com-F}=0

T_{b-com-R=T}_{d-com-F}+T_{d-com-R}−Tₘₘₐₓ

(3) T_{d-com-F}≧Tₘₘₐₓ≧Prescribed Value≈0, then

T_{m-com}=Tₘₘₐₓ

T_{b-com-F}=T_{d-com-F}−Tₘₘₐₓ

T_{b-com-R}=T_{d-com-R}

(4) Situations other than the above (1)-(3)

(Tmmax<Prescribed Value≈0), then

T_{m-com}=0

T_{b-com-F}=T_{d-com-F}

T_{b-com-R}=T_{d-com-R}

As seen in (1) of the Formula 30, when the sum of the absolute value of the front wheel braking torque command value T_{d-com-F} and the absolute value of the rear wheel braking torque command value T_{d-com-R}, i.e., the absolute value of the braking torque command value T_{d-com}, is less than the absolute value of the maximum regenerative torque Tₘₘₐₓ, then the regenerative cooperative braking control unit 11 establishes regenerative braking only. This regenerative braking is accomplished by setting both the front wheel hydraulic braking torque command value T_{b-com-F} and the rear wheel hydraulic braking torque command value T_{b-com-R} to “0” and setting the regenerative braking torque command value Tm-com to the braking torque command value T_{d-com}.

As seen in (2) of the Formula 30, when the absolute value of the braking torque command value T_{d-com} is greater than or equal to the absolute value of the maximum regenerative torque Tₘₘₐₓ and the absolute value of the front wheel braking torque command value T_{d-com-F} is less than the absolute value of the maximum regenerative torque Tₘₘₐₓ, the regenerative cooperative braking control unit 11 establishes front wheel regenerative braking and rear wheel hydraulic braking. The cooperative braking is accomplished by setting the front wheel hydraulic braking torque command value T_{b-com-F} to “0,” setting the rear wheel hydraulic braking torque command value T_{b-com-R} to the value obtained by subtracting the maximum regenerative torque Tₘₘₐₓ from the braking torque command value T_{d-com}, and setting the regenerative braking torque command value T_{m-com} to the maximum regenerative torque Tₘₘₐₓ.

As seen in (3) of the Formula 30, when the absolute value of the maximum regenerative torque Tₘₘₐₓ is greater than or equal to a prescribed value that is close to “0” and the absolute value of the front wheel braking torque command value T_{d-com-F} is greater than or equal to the absolute value of the maximum regenerative torque Tₘₘₐₓ, the regenerative cooperative braking control unit 11 establishes front wheel regenerative braking and front and rear wheel hydraulic braking. The cooperative braking is accomplished by setting the front wheel hydraulic braking torque command value T_{b-com-F} to the value obtained by subtracting the maximum regenerative torque Tₘₘₐₓ from the front wheel braking torque command value T_{d-com-F}, setting the rear wheel hydraulic braking torque command value T_{b-com-R} to the rear wheel braking torque command value T_{d-com-R}, and setting the regenerative braking torque command value T_{m-com} to the maximum regenerative torque Tₘₘₐₓ.

As seen in (4) of the Formula 30, when the absolute value of the maximum regenerative torque Tₘₘₐₓ is less than a prescribed value that is close to “0,” the regenerative cooperative braking control unit 11 establishes hydraulic braking only by setting the front wheel hydraulic braking torque command value T_{b-com-F} to the front wheel braking torque command value T_{d-com-F}, setting the rear wheel hydraulic braking torque command value T_{b-com-R} to the rear wheel braking torque command value T_{d-com-R}, and setting the regenerative braking torque command value T_{m-com} to “0.”

In step S12, the regenerative cooperative braking control unit 11 receives the current gear ratio C of the continuous variable transmission 14 from the continuous variable transmission control unit 16, which is configured and arranged to act as a gear ratio detecting device.

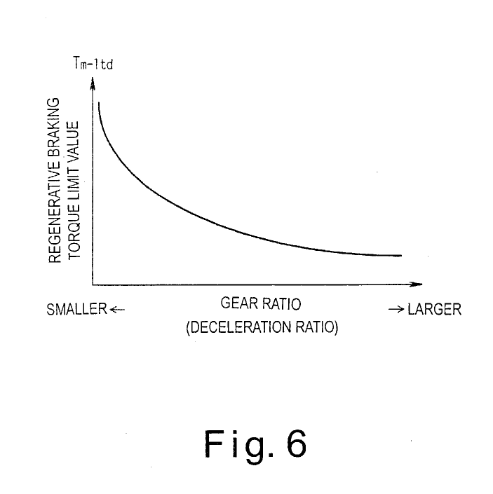

In step S13, the regenerative cooperative braking control unit 11 uses the control map shown in FIG. 6 to set the regenerative braking torque limit value T_{m-ltd} corresponding to the current gear ratio C of the continuous variable transmission 14 received from step S12. In the control map of FIG. 6, the horizontal axis indicates the gear ratio, the vertical axis indicates the regenerative braking torque limit value T_{m-ltd}, and the curve is downwardly convex such that the regenerative braking torque limit value T_{m-ltd} becomes smaller as the gear ratio C, i.e., the deceleration ratio, becomes larger. When, as in this embodiment, the regenerative braking torques of the motor generators 12 and 13 are imparted to the front wheels 10FL and 10FR through the continuously variable transmission 14, the total regenerative braking torque delivered to the front wheels 10FL and 10FR becomes larger as the gear ratio C becomes larger even if the total regenerative braking torque from the motor generators 12 and 13 remain substantially constant. Therefore, the regenerative braking torque limit value T_{m-ltd} is set such that its value is small when the gear ratio C is large in order to prevent the regenerative braking torque that is actually imparted to the front wheels 10FL and 10FR from becoming too large.

In step S14, the regenerative cooperative braking control unit 11 determines if the regenerative braking torque command value T_{m-com} apportioned in step S11 is greater than or equal to the regenerative braking torque limit value T_{m-ltd} set in step S13. If the regenerative braking torque command value T_{m-com} is greater than or equal to the regenerative braking torque limit value T_{m-ltd}, then the regenerative cooperative braking control unit 11 proceeds to step S15. If not, control proceeds to step S16.

In step S15, the regenerative cooperative braking control unit 11 resets the regenerative braking torque command value T_{m-com} to the value of the regenerative braking torque limit value T_{m-ltd} and resets the hydraulic braking torque command value T_{b-com} to the value obtained by subtracting the regenerative braking torque limit value from the braking torque command value T_{d-com}. Furthermore, similarly to step S11, the regenerative cooperative braking control unit 11 apportions the hydraulic braking torque command value into the front and rear wheel hydraulic braking torque command values T_{b-com-F} and T_{b-com-R} before proceeding to step S17. In other words, the regenerative cooperative braking control unit 11 calculates the front wheel hydraulic braking torque command value T_{b-com-F} by subtracting the regenerative braking torque limit value T_{m-ltd} from the front wheel braking torque command value T_{d-com-F} apportioned based on the front-rear wheel braking force distribution control map shown in FIG. 5 and sets the rear wheel hydraulic braking torque command value T_{b-com-R} to the value of the rear wheel braking torque command value T_{d-com-R} apportioned based on the same control map shown in FIG. 5.

Meanwhile, in step S16, the regenerative cooperative braking control unit 11 assigns the regenerative braking torque command value T_{m-com} set in step S11 as the regenerative braking torque command value T_{m-com} without modification and assigns the hydraulic braking torque command value T_{b-com} as the hydraulic braking torque command value T_{b-com} without modification before proceeding to step S17. In other words, the front wheel hydraulic braking torque command value T_{b-com-F} remains the same the front wheel hydraulic braking torque command value T_{b-com-F} and the rear wheel hydraulic braking torque command value T_{b-com-R} remains the same rear wheel hydraulic braking torque command value T_{b-com-R}.

In step S17, the regenerative cooperative braking control unit 11 multiplies the front and rear wheel hydraulic braking torque command values T_{b-com-F} and T_{b-com-R} set in step S15 or S16 by a vehicle factor constant K₃, thereby calculating the front and rear wheel brake fluid pressure command values P_{b-com-F} and P_{b-com-R}.

In step S18, the regenerative cooperative braking control unit 11 sends the regenerative braking torque command value T_{m-com} set in step S15 or S16 to the motor control unit 9 and sends the front and rear wheel brake fluid pressure command values P_{b-com-F} and P_{b-com-R} calculated in step S17 to the brake fluid pressure control unit 7. Control then returns to the main program.

With the processing just described, during the period from accelerator OFF until brake ON, the feed forward component T_{d-FF} of the braking torque command value corresponding to the target deceleration α_{dem} is calculated while updating as required the pre-brake operation deceleration α₀ and updating as required the engine brake deceleration base value α_{eng0}. In particular, during the period from accelerator OFF until brake ON, as required, the pre-brake operation deceleration α₀ is updated to the value of either the vehicle deceleration αᵥ or the engine brake deceleration estimate value α_{eng} at that time and the engine brake deceleration base value α_{eng0} is updated to the engine brake deceleration estimate value α_{eng} at that time. Under these conditions, the braking torque command value T_{d-com} comprises only the braking torque command value feed forward component T_{d-FF}, and therefore is inherently reflected in the vehicle deceleration αᵥ due to the engine braking force. Also, since the braking torque command value T_{d-com} during the period from accelerator OFF until brake ON is smaller than a braking torque command value T_{d-com} occurring when the brake pedal 1 is depressed so long as downshifting is not performed, the front wheel hydraulic braking torque command value T_{b-com-F} and rear wheel hydraulic braking torque command value T_{b-com-R} are both set to “0” and the regenerative braking torque command value T_{m-com} is set to the braking torque command value T_{d-com}.

On the other hand, when the brake pedal 1 is depressed, the value of either the vehicle deceleration αᵥ or the engine braking deceleration estimate value α_{eng} at that time is saved as the pre-brake operation deceleration α₀, and the value of the engine braking deceleration estimate value α_{eng} at that time is saved as the engine braking deceleration base value α_{eng0}. The base deceleration α_{B} corresponding to the engine braking deceleration estimate value α_{eng} at that time is calculated using the resulting pre-brake operation deceleration α₀ and the engine braking deceleration base value α_{eng0}, and the braking torque command value feedback component T_{d-FB} is calculated based on the base deceleration α_{B}, the actual vehicle deceleration αᵥ and the reference deceleration α_{ref}. The braking torque command value T_{d-com} is the sum of the braking torque command value feedback component T_{d-FB} and the braking torque command value feed forward component T_{d-FF}. If the time T_{J} from accelerator OFF to brake ON was greater than or equal to prescribed time T_{J0}, which corresponds to the time required for the engine braking force to converge, then the vehicle deceleration αᵥ at that time has been assigned as the value of the pre-brake operation deceleration α₀. Consequently, if an engine braking force (deceleration resulting from an upward slope or acceleration resulting from a downward slope) is acting on the vehicle at the time of brake operation, then those influences are expressed in the vehicle deceleration αᵥ and reflected in the pre-brake operation deceleration α₀. Therefore, the base deceleration α_{B} is a value that reflects these acceleration/deceleration influences and the braking torque command value feedback component T_{d-FB} corresponding to the difference between this base deceleration α_{B}. On the other hand, the vehicle deceleration αᵥ is a value that reflects only fluctuations in the engine braking torque. Thus, so long as the brake pedal operation amount is fixed and the braking torque command value feed forward component T_{d-FF} remains substantially constant, then the deceleration intended by the driver can be achieved.

Also, even when downshifting or the like causes the engine braking force to change during braking, the difference between the engine braking deceleration estimate value α_{eng} at that time and the engine braking deceleration base value α_{eng0} can be reflected in the base deceleration α_{B}. Consequently, even after such a change occurs, the deceleration intended by the driver can continue to be achieved based on the braking torque command value feedback component T_{d-FB}, which corresponds to the difference between the base deceleration α_{B} and vehicle deceleration αᵥ.

If the time T_{J} from accelerator OFF until brake ON is less than prescribed time T_{J0}, which is equivalent to the time required for the engine braking force to converge, then the pre-brake operation deceleration α₀ is set to the engine braking deceleration estimate value α_{eng}. Consequently, the deceleration intended by the driver can be achieved after the engine braking force converges.

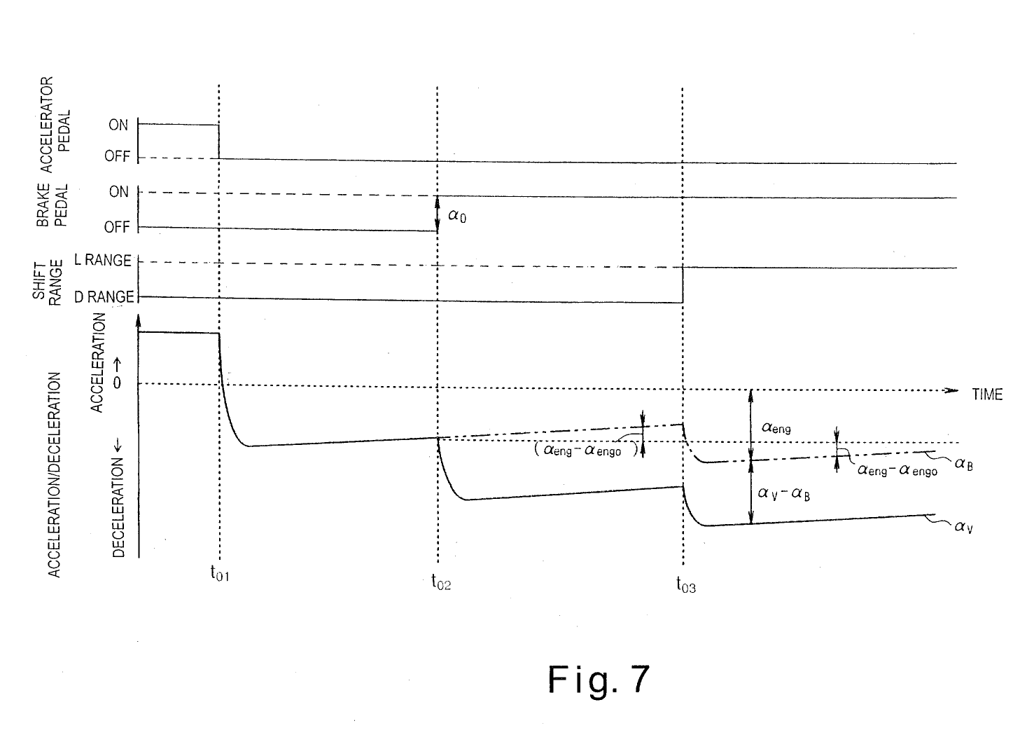

Referring now to FIG. 7, the time chart shows the change in the vehicle acceleration/deceleration over time achieved with the processing shown in FIG. 3. In this time chart, while the vehicle is traveling on a level road, accelerator OFF occurs at time t₀₁, brake ON occurs at time t₀₂, and downshifting occurs at time t₀₃. Also, the amount by which the brake pedal 1 is depressed, i.e., the master cylinder pressure P_{mc}, remains constant after brake ON. When accelerator OFF occurs at time t₀₁, deceleration of the vehicle occurs due to engine braking but the value of that deceleration gradually increases (decreases in terms of the magnitude of deceleration) as the traveling speed of the vehicle decreases.

When brake ON occurs at time t₀₂, the vehicle deceleration αᵥ at that time is assigned as the pre-brake operation deceleration α₀ and the engine braking deceleration estimated value α_{eng} at that time is assigned as the engine braking deceleration base value α_{eng0}. Thus, after time t₀₂, the deceleration (αᵥ−α_{B}) corresponding to the brake pedal depression amount is added to that the deceleration α_{B} (=α₀) that existed up until that time. Thereafter, as the vehicle traveling speed decreases and the engine braking deceleration estimated value α_{eng} increases (decreases in terms of the magnitude of deceleration), the deceleration base value α_{B} increases by the difference between the engine braking deceleration estimated value α_{eng} and the engine braking deceleration base value α_{eng0}. As a result, the value of the vehicle deceleration αᵥ produced by the brake fluid pressure control and the regenerative brake control increases (decreases in terms of the magnitude of deceleration) by the amount of the increase in engine braking torque.

When downshifting occurs at time t₀₃, the engine braking deceleration estimated value α_{eng} decreases (increases in terms of the magnitude of deceleration) accordingly and the deceleration base value α_{B} decreases (increases in terms of the magnitude of deceleration) by the difference between this engine braking deceleration estimated value α_{eng} and the engine braking deceleration base value α_{eng0}. As a result, the value of the vehicle deceleration αᵥ produced by the brake fluid pressure control and the regenerative brake control decreases (increases in terms of the magnitude of deceleration) by the amount of the increase in engine braking torque. Afterwards, however, the engine braking force will increase as the vehicle speed decreases and the value of the vehicle deceleration αᵥ will gradually increase (decrease in terms of the magnitude of deceleration).

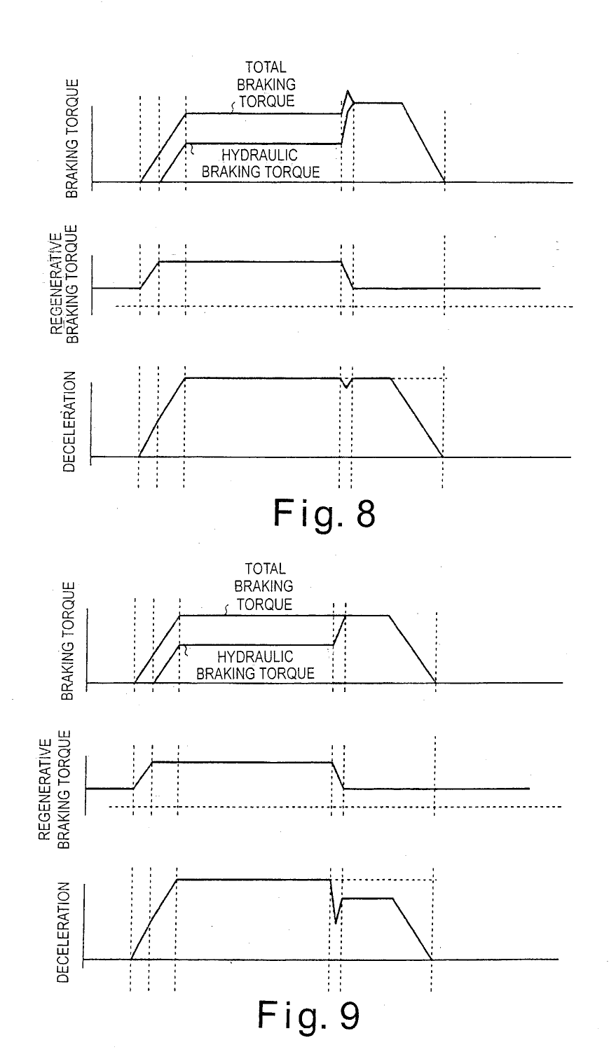

FIG. 8 shows a simulation of how the deceleration of the vehicle changes in a situation where the regenerative braking torque decreases suddenly during execution of the braking force control processing described in FIG. 3. Although, as explained previously, the target deceleration α_{dem} is a negative value, and thus, the various braking torques are expressed as negative values, here all decelerations and torques are expressed as absolute values, i.e., magnitudes only. In this embodiment, the regenerative braking torque and hydraulic braking torque are controlled while feeding back the deceleration αᵥ of the vehicle. Therefore, if, for example, the regenerative braking torque decreases suddenly and the vehicle deceleration αᵥ is about to decrease, the decrease in the vehicle deceleration αᵥ is suppressed or prevented by quickly increasing the hydraulic braking torque. Neither the deceleration during the transient period while the regenerative braking torque is decreasing rapidly, nor the steady deceleration that occurs thereafter changes very much in comparison to the value preceding the sudden change in regenerative braking torque. Thus, even in this kind of situation, the deceleration intended by the driver can continue to be achieved.

Conversely, FIG. 9 (numeric values are shown as absolute values) shows a case where the target deceleration is simply set based on the brake pedal depression amount and the hydraulic braking torque is controlled so as to make the deceleration of the vehicle match the target deceleration. In this case, only after the actual vehicle deceleration begins to decrease is the hydraulic braking torque increased uniformly. As a result, both the deceleration during the transient period while the regenerative braking torque is decreasing rapidly and the steady deceleration that occurs thereafter change greatly and it is difficult to continue achieving the deceleration intended by the driver.

As mentioned above, this embodiment sets the regenerative braking torque limit value T_{m-ltd} in accordance with the current gear ratio C of the continuously variable transmission 14. When the regenerative braking torque command value T_{m-com} set according to the maximum regenerative torque Tₘₘₐₓ alone is greater than or equal to the regenerative braking torque limit value T_{m-ltd}, this embodiment resets the regenerative braking torque command value T_{m-com} to the regenerative braking torque limit value T_{m-ltd} and sets the hydraulic braking torque command value T_{b-com} in accordance with the same regenerative braking torque limit value T_{m-ltd}. As described previously, the regenerative braking torque limit value T_{m-ltd} is set such that its value is smaller when the actual gear ratio C of the continuously variable transmission 14 is larger. Consequently, even when gear ratio C is large, excessive regenerative braking torque does not act on the front wheels 10FL and 10FR (which are the drive wheels) and, instead, an appropriate regenerative braking torque is delivered at all times.

Although in this embodiment the regenerative braking torque limit value T_{m-ltd} is changed continuously because the transmission 14 is a continuously variable transmission, it is also acceptable for the regenerative braking torque limit T_{m-ltd} to be changed in a step-like manner when a conventional step-shifting type transmission is used.

In the illustrated embodiment, the motor control unit 9 constitutes the motor generator control device of the present invention, while steps S14 to S18 of the processing described in FIG. 3 constitute a regenerative braking force maximum value setting device.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially”, “about” and “approximately” as used herein mean a reasonable amount of deviation of the modified term such that the end result is not significantly changed.

This application claims priority to Japanese Patent Application No. 2002-060982. The entire disclosure of Japanese Patent Application No. 2002-060982 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A brake control apparatus comprising:
a motor generator arranged and configured to produce a regenerative braking force that is to be imparted to a drive wheel;
a transmission operatively coupled to the motor generator to transfer the regenerative braking force from the motor generator to the drive wheel through the transmission; and
a controller operatively coupled to the motor generator and configured to control a maximum value of the regenerative braking force based on a gear ratio of the transmission.

2. A brake control apparatus comprising:
a motor generator arranged and configured to produce a regenerative braking force that is to be imparted to a drive wheel; and
a transmission operatively coupled to the motor generator to transfer the regenerative braking force from the motor generator to the drive wheel through the transmission;
a gear ratio detecting device arranged and configured to detect a gear ratio of the transmission;
a motor generator control unit arranged and configured to control the regenerative braking force produced by the motor generator based on at least one vehicle operating state; and
a regenerative braking force maximum value setting device configured to set a maximum value of the regenerative braking force of the motor generator based on the gear ratio detected by the gear ratio detecting device.

3. The brake control apparatus as recited in claim 2, wherein
the motor generator is further arranged and configured to produce a driving force that is to be imparted to the drive wheel through the transmission.

4. The brake control apparatus as recited in claim 2, wherein
the regenerative braking force maximum value setting device is further configured to decrease the maximum value of the regenerative braking force of the motor generator when a larger gear ratio is detected by the gear ratio detecting device, and increase the maximum value of the regenerative braking force of the motor generator when a smaller gear ratio is detected by the gear ratio detecting device.

5. The brake control apparatus as recited in claim 4, wherein
the transmission is a continuously variable transmission.

6. The brake control apparatus as recited in claim 5, further comprising
a hydraulic braking system configured to impart a hydraulic braking force to the drive wheel using brake fluid pressure, and a regenerative cooperative braking control unit arranged and configured to apportion a total braking force to be applied to at least the drive wheel between a hydraulic braking force command value and a regenerative braking force command value.

7. The brake control apparatus as recited in claim 6, wherein
the regenerative cooperative braking control unit is further configured to maximize the regenerative braking force command value when the total braking force to be applied to at least the drive wheel is less than the maximum value of the regenerative braking force of the motor generator.

8. The brake control apparatus as recited in claim 2, wherein
the transmission is a continuously variable transmission.

9. The brake control apparatus as recited in claim 2, further comprising
a hydraulic braking system configured to impart a hydraulic braking force to the drive wheel using brake fluid pressure, and a regenerative cooperative braking control unit arranged and configured to apportion a total braking force to be applied to at least the drive wheel between a hydraulic braking force command value and a regenerative braking force command value.

10. The brake control apparatus as recited in claim 9, wherein
the regenerative cooperative braking control unit is further configured to maximize the regenerative braking force command value when the total braking force to be applied to at least the drive wheel is less than the maximum value of the regenerative braking force of the motor generator.

11. A brake control apparatus comprising:
braking means for producing a regenerative braking force that is to be imparted to a drive wheel; and
transmission means for changing a driving forcing to be imparted to the drive wheel;
detecting means for detecting a gear ratio of the transmission;
control means for controlling the regenerative braking force produced by the braking means based on at least one vehicle operating state; and
regenerative braking force maximum value setting means for setting a maximum value of the regenerative braking force of the braking means based on the gear ratio of the transmission.

12. A method of controlling a braking force in a vehicle comprising:
detecting a gear ratio of a transmission;
imparting a regenerative braking force produced by motor generator to the transmission; and
limiting a maximum value of the regenerative braking force inputted to the transmission from a motor generator in accordance with the gear ratio of the transmission disposed between a drive wheel and the motor generator.

13. The method as recited in claim 12, wherein
the limiting of the maximum value of the regenerative braking force is controlled so as to decrease the maximum value of the regenerative braking force of the motor generator when a larger gear ratio is detected by the gear ratio detecting device, and increase the maximum value of the regenerative braking force of the motor generator when a smaller gear ratio is detected by the gear ratio detecting device.

14. A vehicle comprising:
a set of wheels including at least one drive wheel;
a motor generator arranged and configured to produce a regenerative braking force and a driving force that are imparted to the drive wheel; and
a transmission disposed between the motor generator and the drive wheel such that the regenerative braking force and the driving force of the motor generator are imparted to the drive wheel through the transmission;
a gear ratio detecting device arranged and configured to detect a gear ratio of the transmission;
a motor generator control unit arranged and configured to control the driving force and the regenerative braking force produced by the motor generator based on the operating state of the vehicle; and
a regenerative braking force maximum value setting device configured to set a maximum value of the regenerative braking force of the motor generator based on the gear ratio detected by the gear ratio detecting device.

15. The vehicle as recited in claim 14, wherein
the regenerative braking force maximum value setting device is further configured to decrease the maximum value of the regenerative braking force of the motor generator when a larger gear ratio is detected by the gear ratio detecting device, and increase the maximum value of the regenerative braking force of the motor generator when a smaller gear ratio is detected by the gear ratio detecting device.

16. The vehicle as recited in claim 14, wherein
the transmission is a continuously variable transmission.

17. The vehicle as recited in claim 14, further comprising
a hydraulic braking system configured to impart a hydraulic braking force to the drive wheel using brake fluid pressure, and a regenerative cooperative braking control unit arranged and configured to apportion a total braking force to be applied to at least the drive wheel between a hydraulic braking force command value and a regenerative braking force command value.

18. The vehicle as recited in claim 17, wherein
the regenerative cooperative braking control unit is further configured to maximize the regenerative braking force command value when the total braking force to be applied to at least the drive wheel is less than the maximum value of the regenerative braking force of the motor generator.

19. The vehicle as recited in claim 17, wherein
the set of wheels further include at least one non-drive wheel operatively coupled to the hydraulic braking system configured to impart the hydraulic braking force to the non-drive wheel using the brake fluid pressure.

20. The vehicle as recited in claim 15, further comprising
an internal combustion engine operatively coupled to the transmission with a clutch disposed between the transmission and the internal combustion engine such that the motor generator operates in parallel with the internal combustion engine.

21. The vehicle as recited in claim 20, wherein
the motor generator is operatively disposed between the internal combustion engine and the transmission.

22. The vehicle as recited in claim 21, further comprising
an additional motor generator operatively coupled to the internal combustion engine to operate in series with the internal combustion engine.
